(19) United States
(12) Patent Application Publication
(10) Pub. No.: US 2010/0095570 A1
(43) Pub. Date: Apr. 22, 2010

(54) CRYSTAL BALL WITH AN AIR EXHAUST STRUCTURE

(76) Inventor: Shung-Lun Yu, Taipei (TW)

Correspondence Address: PAI PATENT & TRADEMARK LAW FIRM, 1001 FOURTH AVENUE, SUITE 3200, SEATTLE, WA, 98154, US

(21) Appl. No.: 12/255,670

(22) Filed: Oct. 22, 2008

(51) Int. Cl. G09F 19/00

(52) U.S. Cl. 40/410

(57) ABSTRACT

A crystal ball includes a crystal ball body holding a fluid and an ornamental in the fluid, and a base that supports the crystal ball body and has a fluid chamber and a protruding portion downwardly extending from the inner top wall of the fluid chamber and defining an exhaust hole in air communication between the inside space of the crystal ball body and the fluid chamber for guiding air bubbles out of the crystal ball body into the fluid chamber inside the base when the crystal ball is turned upside down.

### BACKGROUND OF THE INVENTION

(a) Field of the Invention

The present invention relates to a crystal ball and more particularly, to a crystal ball with air exhaust structure for removing air bubbles from the crystal ball body.

(b) Description of the Prior Art

A crystal ball is an ornamental ball that delivers virtual snowfall scene and light effect. A conventional crystal ball generally comprises a transparent ball mounted on a base to hold a fluid, snowflake-like chips and a scene ornament. However, a crystal ball may contain air bubbles in the fluid. The formation of an air bubble in a crystal ball may be because of the following reasons: 1. Tinny air bubbles are mixed with the fluid accidentally when the fluid is being filled into the crystal ball, and tinny air bubbles are joined into one a big air bubble. 1. The structural design of the ornament does not facilitate exhaust of air during filling of the fluid, and air maintained in holes in the ornament cause the formation of air bubbles after filling of the fluid in the ball. 3. Poor sealing status of the crystal ball or other factors. A crystal ball that contains an air bubble in the fluid is an imperfect product, affecting the sense of beauty. When a big air bubble exists in the fluid, the crystal ball must be taken back and reconstructed.

### SUMMARY OF THE INVENTION

The present invention has been accomplished under the circumstances in view. It is one object of the present invention to provide a crystal ball that has an exhaust hole for guiding air bubbles out of the crystal ball body to a concealed fluid chamber outside the crystal ball body. To achieve this and other objects of the present invention, the crystal ball comprises a base, and a crystal ball body mounted on the base to hold a fluid and an ornamental in the fluid. The base comprises a fluid chamber, and an exhaust hole in air communication between the inside space of the crystal ball body and the fluid chamber for guiding air bubbles out of the crystal ball body into the fluid chamber inside the base when the crystal ball is turned upside down.

### BRIEF DESCRIPTION OF THE DRAWINGS

FIG. 1 is a perspective view of a crystal ball in accordance with a first embodiment of the present invention.

FIG. 2 is an exploded view of the crystal ball in accordance with the first embodiment of the present invention.

FIG. 3 is a longitudinal sectional view of the crystal ball in accordance with the first embodiment of the present invention.

FIG. 4 is an oblique bottom elevation of the base for the crystal ball in accordance with the first embodiment of the present invention.

FIG. 5 is an oblique bottom elevation of an alternate form of the base for the crystal ball in accordance with the first embodiment of the present invention.

FIG. 6 is an oblique bottom elevation of another alternate form of the base for the crystal ball in accordance with the first embodiment of the present invention.

FIG. 7 is a schematic drawing of the first embodiment of the present invention, showing the crystal ball turned upside down.

FIG. 8 is a sectional view in an enlarged scale of a part of the crystal ball in accordance with the first embodiment of the present invention, showing the crystal ball turned upside down and bubbles moved upwards in the fluid.

FIG. 9 corresponds to FIG. 8, showing bubbles entered the fluid chamber of the base.

FIG. 10 is a schematic sectional view of a crystal ball in accordance with a second embodiment of the present invention.

FIG. 11 is a schematic sectional view of a crystal ball in accordance with a third embodiment of the present invention.

### DETAILED DESCRIPTION OF THE PREFERRED EMBODIMENTS

Referring to the annexed drawings in detail, a crystal ball in accordance with the present invention is shown comprising a crystal ball body 1, a base 2 and an ornament 3. The base 2 is so designed that air bubbles in the crystal ball body 1 are eliminated.

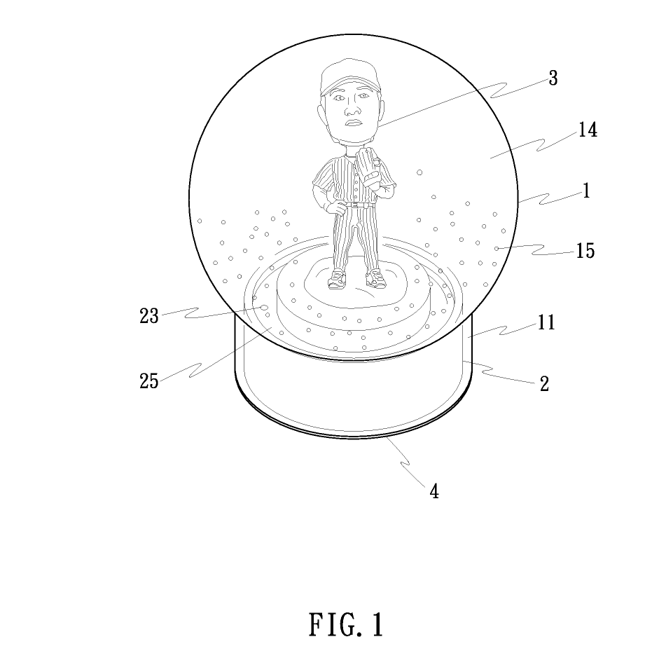

According to a first embodiment of the present invention, the crystal ball body 1, as shown in FIGS. 1˜3, is a hollow transmissive member made from glass or plastics by means of blow molding or injection molding. The crystal ball body 1 can be made having a spherical shape, oval shape or other geometric shape, or an irregular shape. As illustrated in FIGS. 1˜3, the crystal ball body 1 has a downwardly extending tubular bottom neck 11 and an opening 12 in the bottom side of the tubular bottom neck 11 in communication with the inside space of the crystal ball body 1. The crystal ball body 1 further has an inside step 13 extending around the junction between the crystal ball body 1 and the tubular bottom neck 11. Through the opening 12, a fluid 14 and snowflake-like chips 15 are filled in the crystal ball body 1.

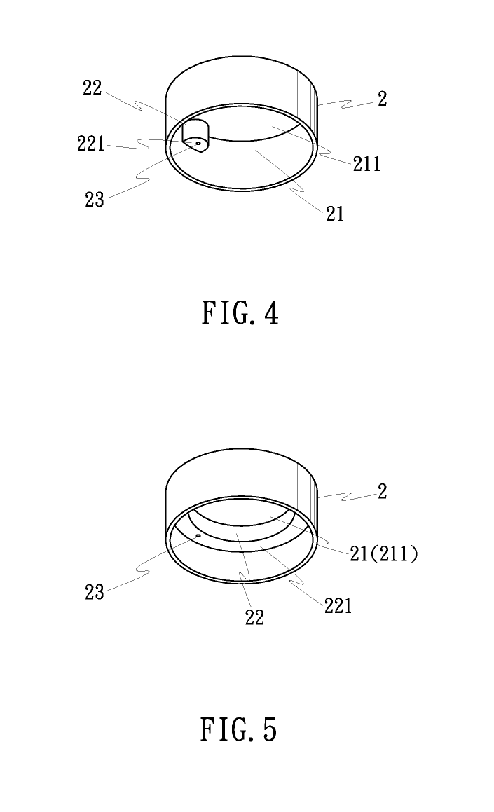

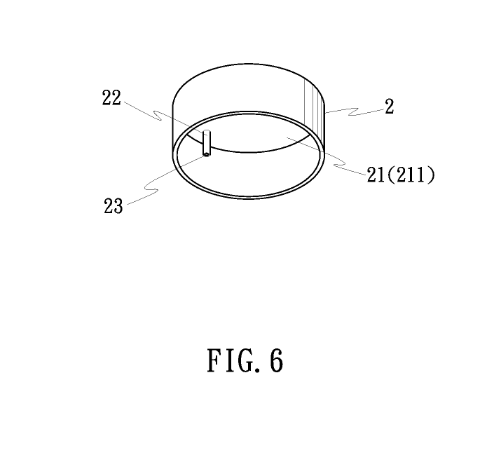

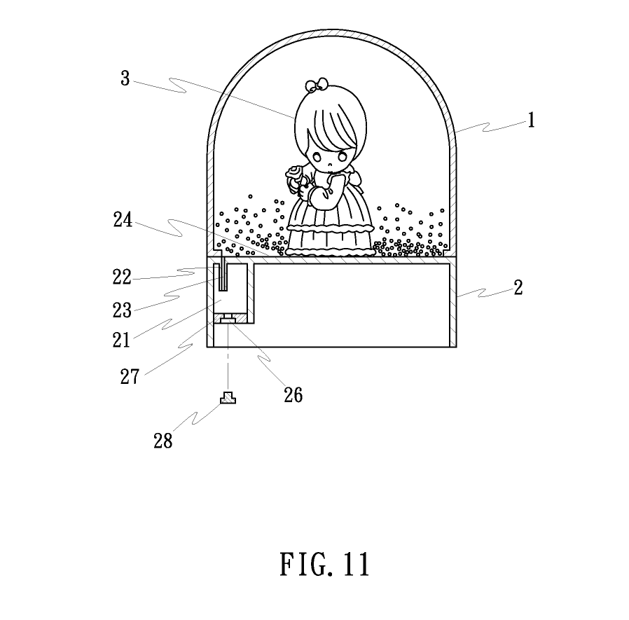

Referring to FIGS. 1˜3 again, the base 2 is a plastic block member configured to match with the shape of the tubular bottom neck 11 of the crystal ball body 1 such that the base 2 can be fastened to the inside of the tubular bottom neck 11 of the crystal ball body 1. Alternatively, the base 2 can be configured for fastening to the outside of the tubular bottom neck 11 of the crystal ball body 1 (see FIG. 11). The base 2 comprises therein a fluid chamber 21, a protruding portion 22 downwardly protruded from the inner top wall 211 of the fluid chamber 21. The protruding portion 22 can be a protruding block (see FIG. 4), annular flange (see FIG. 5), or tube (see FIG. 6), defining an exhaust hole 23. The exhaust hole 23 cuts through the bottom side 221 of the protruding portion 22 and disposed in communication with the inside space of the crystal ball body 1. The base 2 further has a recessed portion 25 formed in the top wall 24. The recessed portion 25 can be an annular groove. The exhaust hole 23 cuts through the bottom side 221 of the protruding portion 22 and the recessed portion 25. Therefore, the exhaust hole 23 is disposed in communication with the inside space of the crystal ball body 1 after connection between the base 2 and the crystal ball body 1.

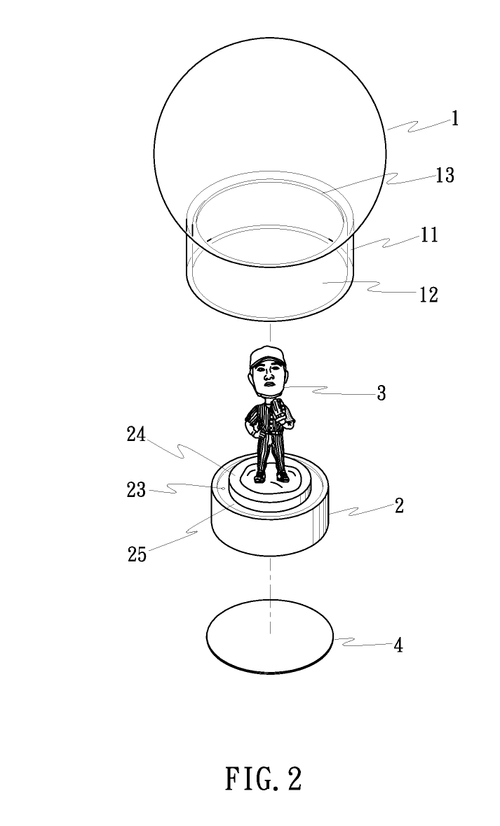

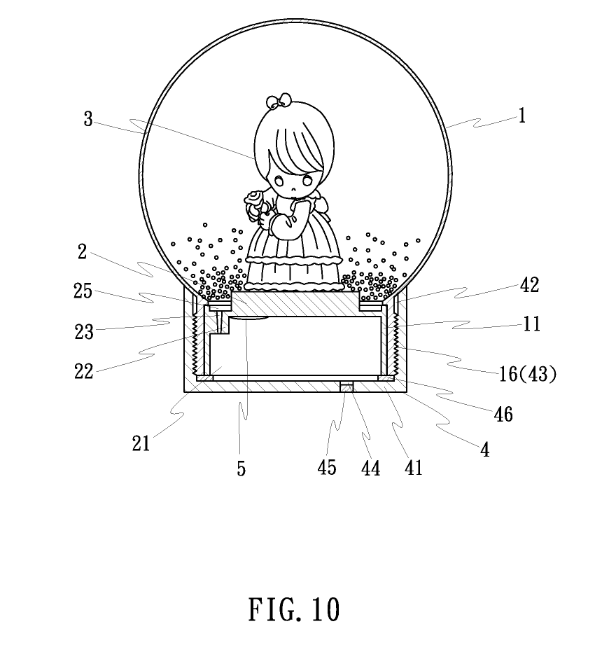

The ornament 3, as shown in FIGS. 1 and 2, is the theme ornament in the crystal ball. The ornament 3 can be made in any form, for example, a character figure, a building, an animal, or a doll (see FIG. 10). The ornament 3 is bonded to the top wall 24 of the base 2. When the base 2 is fastened to the tubular bottom neck 11 of the crystal ball body 1, the ornament 3 is kept standing in the crystal ball body 1.

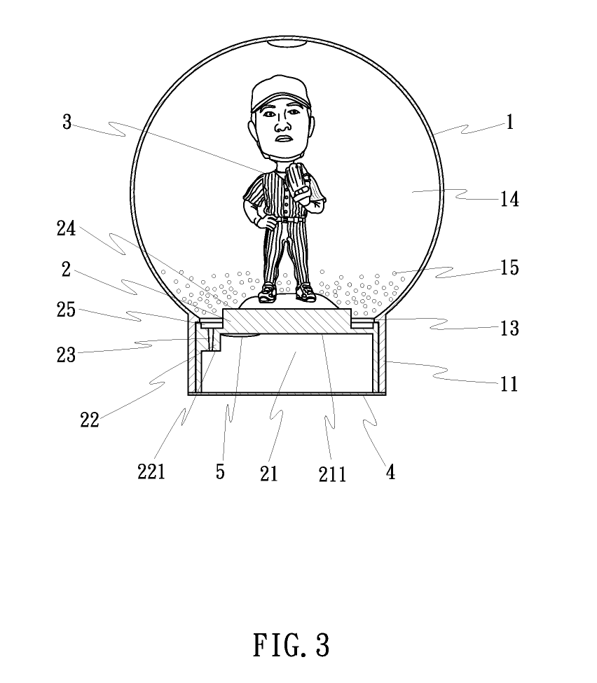

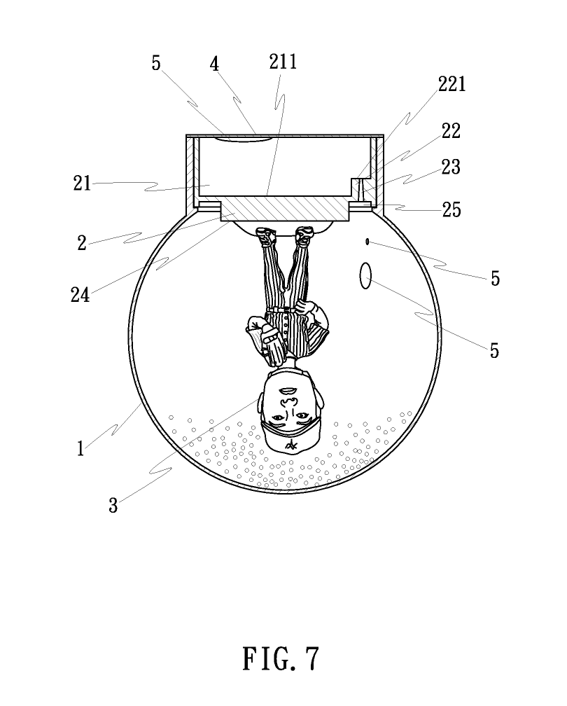

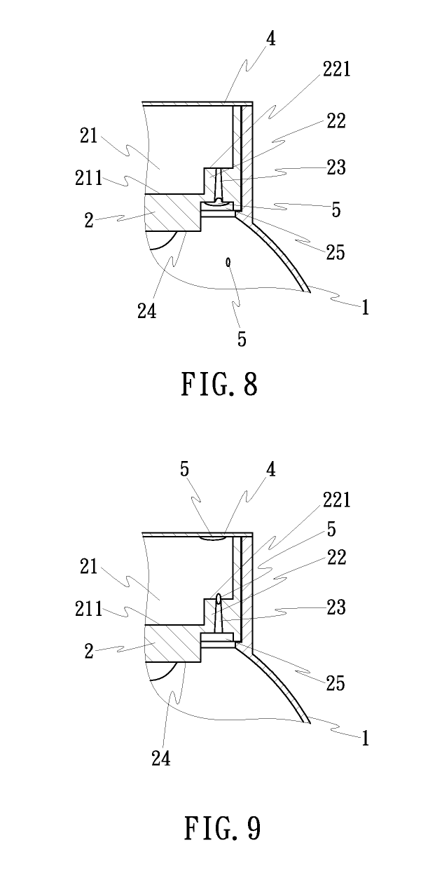

The structural design of the fluid chamber 21, protruding portion 22 and exhaust hole 23 of the base 2 eliminates bubbles from the fluid 14 in the crystal ball body 1. When air bubbles 5 are produced in the fluid 14 in the crystal ball body 1, as shown in FIG. 7, turn the whole crystal ball upside down. At this time, the air bubbles 5 rise in the fluid 14 because they are less dense than water, and then go out of the crystal ball body 1 into the fluid chamber 21 of the base 2 via the exhaust hole 23 (see FIGS. 8 and 9). When all the air bubbles 5 enter the fluid chamber 21, return the crystal ball to the normal standing position again, keeping the air bubbles 5 in the top side inside the fluid chamber 21 around the inner top wall 211 (see FIG. 3). Because the exhaust hole 23 is formed in the protruding portion 22 below the elevation of the inner top wall 211 of the fluid chamber 21, the air bubbles 5 will not go back to the inside of the crystal ball body 1, i.e., the air bubbles 5 are concealed in the fluid chamber 21 and kept from sight when a person is watching the crystal ball.

Further, as shown in FIGS. 2 and 3, a seal means 4 is fastened to the tubular bottom neck 11 of the crystal ball body 1 to seal the opening 12, avoiding leakage of the fluid 14. The seal means 4 can be a plastic film covered on the opening 12 of the tubular bottom neck 11. The seal means 4 can be sealed to the tubular bottom neck 11 to seal the opening 12 by means of a thermal bonding technique.

FIG. 10 shows a crystal ball in accordance with a second embodiment of the present invention. According to this second embodiment, the tubular bottom neck 11 of the crystal ball body 1 is provided with a first thread (male thread) 16; the seal means 4 comprises a cap 41 that has a second thread (female thread) 43 formed in the inside open fluid chamber 42, and a gasket ring 46 mounted in the inside open fluid chamber 42. By means of threading the second thread 43 of the cap 41 onto the first thread 16 the tubular bottom neck 11 of the crystal ball body 1, the cap 41 is fastened to the tubular bottom neck 11, and the gasket ring 46 is sealed in between the tubular bottom neck 11 and the cap 41. Further, the cap 41 has a filling hole 44 that is sealed with a plug 45 after filling of the fluid 14 in the crystal ball body 1.

FIG. 11 shows a crystal ball in accordance with a third embodiment of the present invention. According to this third embodiment, the crystal ball body 1 eliminates the aforesaid tubular bottom neck 11, and is directly bonded to the top wall 24 of the base 2 by means of a thermal bonding technique. Further, the fluid chamber 21 of the base 2 is formed in one lateral side of the base 2 and, the inner top wall 211 has a tubular protruding portion 22 downwardly extending from the inner top wall 211 and defining an exhaust hole 23 for exhaust of air bubbles from the crystal ball body 1. Further, a cap 26 is bonded to the bottom side of the fluid chamber 21, having a fill hole 27 that is in vertical alignment with the exhaust hole 23 and sealed with a plug 28. This embodiment has a relatively simpler structure, lowering the manufacturing cost.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A crystal ball, comprising a base, a crystal ball body mounted on said base, a fluid filled in said crystal ball body, and ornamental means set in said crystal ball body, wherein said base comprises a fluid chamber, a protruding portion downwardly extending from an inner top wall thereof inside said fluid chamber, and an exhaust hole cut through said protruding portion in air communication between the inside space of said crystal ball body and said fluid chamber of said base.

2. The crystal ball as claimed in claim 1, wherein said crystal ball body comprises a tubular bottom neck, and an opening formed in a bottom side of said tubular bottom neck in communication with the inside space of said crystal ball body; said base is fastened to the inside of said opening of said tubular bottom neck.

3. The crystal ball as claimed in claim 1, wherein said crystal ball body comprises a tubular bottom neck, and an opening formed in a bottom side of said tubular bottom neck in communication with the inside space of said crystal ball body; said base is fastened to the outside of said tubular bottom neck to seal said opening of said tubular bottom neck.

4. The crystal ball as claimed in claim 1, wherein said protruding portion of said base is a protruding block formed integral with said inner top wall of said fluid chamber and suspending inside said fluid chamber.

5. The crystal ball as claimed in claim 1, wherein said protruding portion of said base is an inside annular flange downwardly protruded from said inner top wall of said fluid chamber and suspending inside said fluid chamber.

6. The crystal ball as claimed in claim 1, wherein said protruding portion of said base is a tube downwardly extending from said inner top wall of said fluid chamber and suspending inside said fluid chamber.

7. The crystal ball as claimed in claim 1, wherein said base comprises a recessed portion formed in a top wall thereof; said exhaust hole extends from a bottom side of said protruding portion to said recessed portion.

8. The crystal ball as claimed in claim 2, further comprising seal means that seals said opening of said tubular bottom neck of said crystal ball body.

9. The crystal ball as claimed in claim 8, wherein said seal means is a thin film bonded to said tubular bottom neck of said crystal ball body to seal said opening.

10. The crystal ball as claimed in claim 8, wherein said tubular bottom neck of said crystal ball body comprises thread means; said seal means comprises a cap, said cap comprising thread means meshed with the thread means of said tubular bottom neck of said crystal ball body, and a gasket ring mounted in said cap and sealed in between said cap and said tubular bottom neck of said crystal ball body.

11. The crystal ball as claimed in claim 8, wherein said cap comprises a filling hole and a plug that seals said filling hole.

12. The crystal ball as claimed in claim 1, wherein said fluid chamber is formed in one lateral side inside said base; said protruding portion is a tubular member downwardly suspending in said fluid chamber; said base further comprises a cap bonded to a bottom wall of said fluid chamber, said cap comprising a filling hole, and a plug sealing said filling hole.
